(19) United States
(12) Patent Application Publication
(10) Pub. No.: US 2006/0152022 A1
(43) Pub. Date: Jul. 13, 2006

(54) Crash box radiator support

(76) Inventors: Stephan Rech-Linker, Aidlingen (DE); Matthias Scheffzuek, Tuebingen (DE)

Correspondence Address: KENYON & KENYON LLP, ONE BROADWAY, NEW YORK, NY, 10004, US

(21) Appl. No.: 10/540,656

(22) PCT Filed: Nov. 21, 2003
(86) PCT No.: PCT/EP03/13070

§ 371 Date: Nov. 9, 2005

(30) Foreign Application Priority Data
Dec. 23, 2002 (DE) 102607931

(51) Int. Cl. B60R 19/52

(52) U.S. Cl. 293/115

(57) ABSTRACT

A crash box for a motor vehicle, e.g., for a passenger automobile, includes a plurality of fold beads arranged vertically and/or transversely with respect to a predetermined direction of deformation of the crash box, and at least one mounting element secured to the crash box. The mounting element is arranged on one of the fold beads but is cut out over a fold bead and/or provided with an oppositely curved, similar fold bead.

The invention relates to a crash box for a motor vehicle, in particular for a passenger automobile, in accordance with the preamble of claim 1.

The use of a crash box in a conventional passenger automobile is generally known. The purpose of the crash box is to absorb energy through controlled deformation in the event of an accident. To ensure that a damaged vehicle is inexpensive to repair, the separating point between a longitudinal beam and the crash box is generally in screw-connected form. This screw-connection point is often also used to secure other equipment holders, in which case the configuration must be such that the deformation of the crash box is influenced to the minimum possible extent.

DE 198 50 590 A1 has disclosed a front end region for a motor vehicle, in particular for a passenger automobile with a radiator or heat exchanger arrangement, which is connected to a front end structure at at least two bearing points. In this document, the at least two bearing points are designed in such a manner that in the event of impact-related deformation of the front end supporting structure, they link the heat exchanger arrangement into the deformation characteristic of the front end region in a force-transmitting and force-absorbing way. The heat exchanger arrangement, which may be composed of one or more heat exchangers, is braced into the front end supporting structure in such a manner that as a result of plastic deformation, it makes an additional contribution, in the manner of a soft barrier, to energy absorption and to the distribution of impact energy over large-area parts of the front end region. The region of use is in this case in a front module of a passenger automobile. Although the heat exchanger arrangement is linked into the deformation characteristics in a force-transmitting and force-absorbing way in the event of an impact-related deformation of the front end supporting structure, no details are provided as to the influence of the connection between the heat exchanger arrangement and the front end supporting structure.

DE 100 51 567 A1 has disclosed a vehicle front end structure. A front end element of the vehicle, which includes at least one radiator, has an upper projection, which is secured to an upper insertion hole in a front end wall of the vehicle, and a lower projection, which is secured to a lower insertion hole in the front end wall. If an external force which exceeds a predetermined level acts on the vehicle from the front side, the securing of the upper projection in the upper insertion hole is released, whereas the securing of the lower projection in the lower insertion hole is maintained. This makes it possible to prevent the entire front end element from being detached from the front end wall when the external force acts on the vehicle from the front side.

Accordingly, it is possible to prevent damage to the front end element as a result of the external force, and at the same time the front end element is prevented from hitting a road surface.

The present invention deals with the problem of providing an improved embodiment for a crash box for a motor vehicle.

This problem is solved by the subject matter of the independent claim. Advantageous embodiments form the subject matter of the dependent claims.

The invention is based on the general concept of arranging a mounting element (receiving part) for fitted parts, such as for example a radiator and/or heat exchanger arrangement, on the crash box with the minimum possible influence on the deformation characteristics of the crash box. The invention involves attaching the radiator and/or heat exchanger arrangement directly to the crash box, with the geometric configuration being such that the mounting element, which is U-shaped in form, receives a receiving bolt arranged on the radiator and/or heat exchanger arrangement.

The crash box has a plurality of fold beads arranged vertically and/or transversely with respect to a predetermined direction of deformation, with the mounting element, according to the invention, being arranged in such a way that in each case one limb of the U-shaped mounting element runs on either side of the fold beads, while the part which connects the two U-limbs of the U-shaped receiving part runs transversely with respect to the fold bead and has a similar curvature in the opposite direction to the fold bead, so that the deformation properties are not impeded in any way. The similar, opposite curvature also has the effect of ventilating the mounting element from behind, so that spray water which penetrates can run off or evaporate more quickly, thereby improving the resistance to corrosion.

One particularly expedient embodiment of the solution according to the invention is characterized in that the crash box has crash box parts arranged on both sides of the longitudinal center of the vehicle, and a radiator and/or heat exchanger arrangement, positioned vertically, is arranged on the crash box, substantially transversely with respect to the longitudinal direction of the vehicle, the radiator and/or heat exchanger arrangement in each case having a left-hand and a right-hand receiving bolt, which is received by a respective left-hand and right-hand, upwardly open U-shaped receiving part which is arranged on the respective crash box part, and in that the radiator and/or heat exchanger arrangement, in a mounting state, is mounted such that it can rotate about an axis defined by the left-hand and right-hand receiving bolt and can be slid downwards into or upwards out of the respective left-hand and right-hand U-shaped receiving part.

The result of this is that fitting of the radiator and/or heat exchanger arrangement is considerably facilitated and accelerated, thereby making it a less expensive operation. To fit the radiator and/or heat exchanger arrangement, the latter is pushed in downwards such that the two receiving bolts move into the respective U-shaped, upwardly open mounting elements, and is prevented from rotational movement along an axis defined by the two receiving bolts by at least one connection at a transverse bridge. There is no need for further connection by screw connection, welding or the like. The radiator and/or heat exchanger arrangement is therefore fixed in the operating state and can easily be removed for repair and/or maintenance work by releasing the at least one connection at the transverse bridge.

The invention offers the advantage of simple fitting and/or maintenance of the radiator and/or heat exchanger arrangement, which in times of ever increasing wage costs helps to reduce production and/or maintenance costs.

It is expediently possible to provide that the left-hand and right-hand receiving bolts have a rubberized protective sheath. The result of this is that any vibration noises which may occur between receiving bolts and crash box do not form or are not transmitted, and consequently have no adverse effect on driving comfort.

According to a particularly expedient embodiment, it is provided that the crash box is arranged at a front or rear end of a motor vehicle. Depending on the type of vehicle, a drive device and an associated radiator and/or heat exchanger arrangement is located in a front or rear part of the motor vehicle. The solution according to the invention is in this case configured in such a way that it can be used in both the front region and the rear region of the vehicle without difficulty.

Further important features and advantages of the invention will emerge from the subclaims, from the drawings and from the associated description of figures with reference to the drawings.

It will be understood that the features described above and those which are yet to be explained below can be used not only in the combination indicated in each instance, but also in other combinations or as stand-alone measures without departing from the scope of the present invention.

Preferred exemplary embodiments of the invention are illustrated in the drawings and explained in more detail in the following descriptions, in which identical reference numerals denote identical or similar or functionally equivalent components. In the drawings:

FIG. 1 shows a perspective view of a crash box according to the invention with a radiator and/or heat exchanger arrangement,

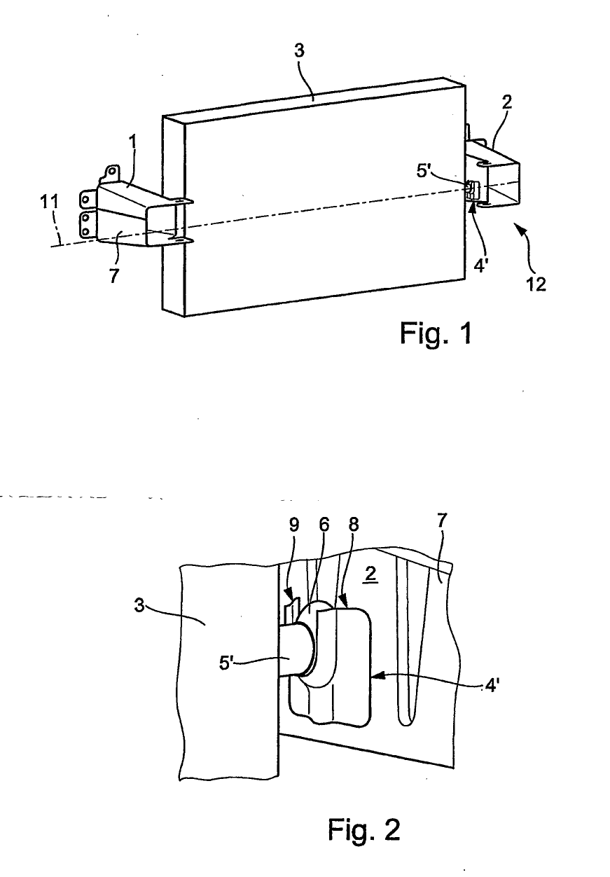

FIG. 2 shows a detail view of a receiving bolt and a mounting element,

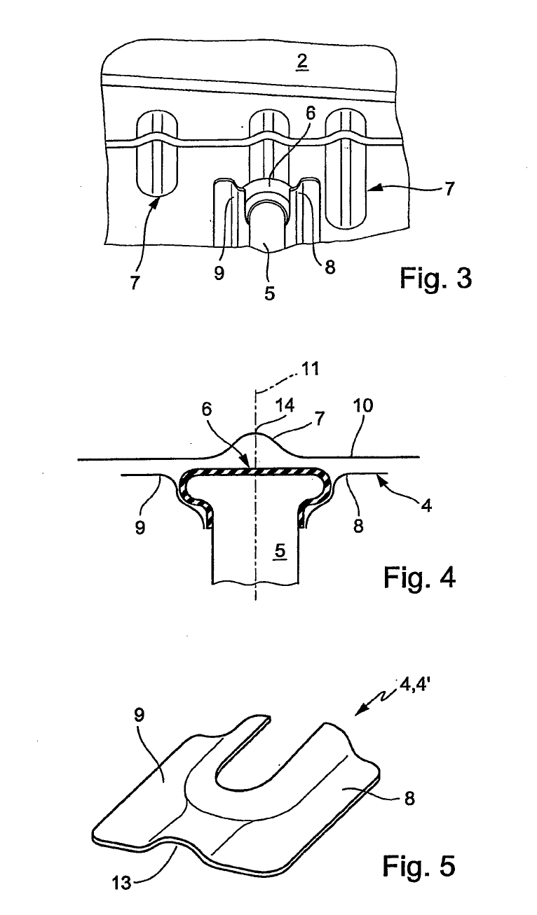

FIG. 3 shows a detail view as in FIG. 2, but from a different perspective,

FIG. 4 shows a cross section through a receiving bolt and a receiving part,

FIG. 5 shows a detail view of a mounting element.

FIG. 1 illustrates a crash box arrangement which includes a left-hand crash box part 1 and a right-hand crash box part 2, a radiator and/or heat exchanger arrangement 3 and a receiving bolt 5 and a mounting element 4. The crash box parts 1, 2 are arranged on both sides of a vehicle longitudinal center (not illustrated in FIG. 1) and hold a radiator and/or heat exchanger arrangement 3, which is suspended between the two crash box parts 1, 2, is positioned vertically and is positioned substantially transversely with respect to a vehicle longitudinal direction, not illustrated in FIG. 1.

The crash box parts 1, 2 form the crash box arrangement, which is not designated further. The purpose of the crash box arrangement is to absorb energy through deformation along a deformation direction 12 in the event of an impact occurring substantially parallel to a vehicle longitudinal direction. As illustrated in FIG. 1, a plurality of fold beads 7, which are arranged vertically and/or transversely with respect to the predetermined deformation direction 12, are for this purpose incorporated in the crash box parts 1, 2. The fold beads 7 form an artificial weakening in the crash box parts 1 and 2 and effect compression and/or bending of the crash box parts 1, 2 at these weak points, and therefore an energy-absorbing action as a result of desired and predetermined deformation, in the event of a force which exceeds a predetermined level acting externally on a vehicle chassis (not shown in FIG. 1).

The radiator and/or heat exchanger arrangement 3 has in each case a left-hand receiving bolt 5 and a right-hand receiving bolt 5′, which engage in respectively associated U-shaped mounting elements 4 and 4′ provided for this purpose. The U-shaped, upwardly open mounting elements 4, 4′ are arranged on the associated crash box part 1 and 2 by way of weld spots.

In mounting state, the radiator and/or heat exchanger arrangement 3 can rotate about an axis of rotation 11, which is defined by the left-hand receiving bolt 5 and the right-hand receiving bolt 5′. At the same time, in the mounting state, the radiator and/or heat exchanger arrangement 3 can be slid downwards into the mounting elements 4 and 4′ or lifted out from the upwardly open U-shaped mounting elements 4, 4′. In an operating state, the radiator and/or heat exchanger arrangement 3 is fixed in place by a connecting element (not shown in FIG. 1) on a transverse bridge (likewise not shown in FIG. 1) and is therefore prevented from rotating about the axis of rotation 11.

As illustrated in FIG. 2, the radiator and/or heat exchanger arrangement 3 is suspended by the receiving bolts 5, 5′ in the mounting elements 4, 4′. A rubberized protective sheath 6 is pulled over that end of the receiving bolts 5, 5′ which is remote from the radiator and/or heat exchanger arrangement 3, which receiving bolts have been pushed vertically downwards into the associated mounting element 4, 4′. The rubberized protective sheath 6 prevents vibrations from being transmitted from the crash box parts 1, 2 to the radiator and/or heat exchanger arrangement 3 and visa versa, and also prevents a noisy relative movement between the receiving bolt 5, 5′ and the mounting element 4, 4′.

It can be seen clearly from FIG. 4 that the mounting element 4 is in each case arranged with a left-hand and a right-hand limb 9, 8 at an intermediate space 10 located between the fold beads 7, with the fold bead 7 itself remaining cut away. Ideally, the axis of rotation 11 runs centrally through the receiving bolt 5 and a base 14 of the fold bead 7. The head-like formation of that end of the receiving bolt 5 which is remote from the radiator and/or heat exchanger arrangement 3 prevents the radiator and/or heat exchanger arrangement 3 from moving transversely with respect to the longitudinal direction of the vehicle, i.e. along the axis of rotation 11, and thereby fixes it in place between the two crash box parts 1, 2.

In accordance with FIG. 2 and FIG. 3, the mounting element 4 is arranged at a lower end of the fold bead 7. In principle, however, it is also conceivable for the mounting element 4 to be arranged at a different position along the fold bead 7. This is made possible by a curvature 13 running in the opposite direction to the fold bead 7 and also parallel to the latter (cf. FIG. 5). The curvature 13, similarly to the fold beads 7 in the crash box parts 1, 2, forms a region which can readily be deformed along the deformation direction 12, i.e. transversely with respect to the profile of a curvature valley.

Moreover, the curvature 13 offers the considerable advantage of providing ventilation for the mounting element 4 from the rear, so that penetrating spray water can escape downward. Without the curvature 13, a blind formation would result, leading to standing water being present therein, with an increased risk of corrosion.

To summarize, the following points should be noted:

A plurality of fold beads 7 are incorporated in the crash box parts 1, 2, producing an artificial weakening and effecting compression and/or bending in the event of a forceful impact along the deformation direction 12.

U-shaped, upwardly open mounting elements 4, 4′ are arranged on the crash box parts 1, 2 by way of weld spots.

The mounting element 4, 4′ is fitted to the fold bead 7 in such a way that in each case the left-hand and right-hand limbs 9, 8 are arranged at the intermediate space 10, and the fold bead 7 itself remains cut away.

The mounting element 4, 4′ has a curvature 13 running in the opposite direction to the fold bead 7, (cf. FIG. 5) and, similarly to the fold beads 7, forms a region which is readily deformable.

1-8. (canceled)

9. A crash box for a motor vehicle, comprising:
a plurality of fold beads arranged at least one of (a) vertically and (b) transversely with respect to a predetermined direction of deformation of the crash box; and
at least one mounting element secured to the crash box;
wherein the mounting element is arranged on one of the fold beads, the mounting element one of (a) recessed above the one of the fold beads and (b) including an oppositely curved fold bead.

10. The crash box according to claim 9, wherein the motor vehicle includes a passenger automobile.

11. The crash box according to claim 9, further comprising:
a first crash box part arranged on a first side of a longitudinal center of the motor vehicle;
a second crash box part arranged on a second side of the longitudinal center of the motor vehicle; and
at least one of (a) a radiator and (b) a heat exchanger arrangement, positioned vertically and arranged substantially transverse to the longitudinal direction of the vehicle, the at least one of (a) the radiator and (b) the heat exchanger arrangement including a first receiving bolt and a second receiving bolt, the first receiving bolt received by a first upwardly open U-shaped receiver part of the mounting element arranged on the first crash box part, the second receiving bolt received by a second upwardly open U-shaped receiver part of the mounting element arranged on the second crash box part.

12. The crash box according to claim 11, wherein the at least one of (a) the radiator and (b) the heat exchanger arrangement, in a mounting state, is mounted to rotate about an axis defined by the first receiving bolt and the second receiving bolt and to slide one of (a) downwardly into and (b) upwardly out of the first U-shaped receiver part and the second U-shaped receiver part.

13. The crash box according to claim 11, further comprising at least one connection arranged at a transverse bridge configured to prevent the at least one of (a) the radiator and (b) the heat exchanger arrangement from rotational movement in an operating state.

14. The crash box according to claim 11, wherein the at least one of (a) the radiator and (b) the heat exchanger arrangement is arranged to hang freely between the first U-shaped receiver part and the second U-shaped receiver part in an operating state.

15. The crash box according to claim 11, wherein the first receiving bolt and the second receiving bolt include a rubberized protective sheath.

16. The crash box according to claim 9, wherein the crash box is arranged at a front end of the motor vehicle.

17. The crash box according to claim 9, wherein the crash box is arranged at a rear end of the motor vehicle.

18. A motor vehicle, comprising:
a crash box, the crash box including:
a plurality of fold beads arranged at least one of (a) vertically and (b) transversely with respect to a predetermined direction of deformation of the crash box; and
at least one mounting element secured to the crash box;
wherein the mounting element is arranged on one of the fold beads, the mounting element one of (a) recessed above the one of the fold beads and (b) including an oppositely curved fold bead.
